(19) United States
(12) Patent Application Publication
(10) Pub. No.: US 2008/0223372 A1
(43) Pub. Date: Sep. 18, 2008

(54) Modified eye and mouth mask structure for escape from dense smoke of fire accident

(76) Inventor: Tsung-Yuan Ku, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,021

(22) Filed: May 29, 2008

Related U.S. Application Data
(63) Continuation-in-part of application No. 10/890,158, filed on Jul. 14, 2004.

(51) Int. Cl. A62B 23/00

(52) U.S. Cl. 128/206.19

(57) ABSTRACT

An eye and mouth mask unit for escape from dense smoke of fire accident comprises an eye and mouth mask, a liquid bag and a package bag unit. The eye and mouth mask and the liquid bag are sealed in the package bag when not in use. The eye and mouth mask comprises a mouth mask body, an eye mask body and two constriction bands. The eye mask body is connected at the upper side of the mouth mask body. The eye mask body is made of transparent plastic film. The two constriction bands are sewed at end corners of two side peripheries of the mouth mask body for hanging on ears of a user so that the eye mask body and the mouth mask body of eye and mouth mask can cover over his eyes, nose and mouth.

### CROSS REFERENCE TO RELATED APPLICATION

This application is a continuation-in-part of U.S. application Ser. No. 10/890,158 filed on 14, Jul. 2004 and entitled “modified eye and mouth mask structure for escape from dense smoke of fire accident”, now pending.

### FIELD OF THE INVENTION

The present invention relates to a modified eye and mouth mask structure for escape from dense smoke of fire accident capable of reducing invasion of dense smoke and, more particularly, to a modified eye and mouth mask structure composed with layers of textile fiber, foam and transparent plastic member; and used at the initial stage of a fire accident to let a user quickly get a mouth mask having a large amount of water to cover over his eyes, mouth and nose, thereby reducing invasion of dense smoke.

### BACKGROUND OF THE INVENTION

Nowadays, the occurrence of fire accident is high, and news about casualty in fire hazards is commonly heard. Generally, the process of a fire accident can be divided into three stages: initial stage, growth stage and maturity stage. In the initial stage of a fire accident, flames take place and a large amount of dense smoke is generated. During the growth and maturity stages, flames start to spread, and the temperature rises quickly. Although most people died in the fire scene are burned black, the real reason of death is not the fire. Instead, most people died in the fire scene were choked to faint by dense smoke generated during the initial stage of the fire accident, or their eyes were invaded by dense smoke so that they couldn't make use of their visual functions to escape from the fire scene. They were not directly burned dead during the growth and maturity stages of the fire accident.

During the initial stage of a fire accident, in order to prevent from inhaling dense smoke, it is necessary for a person at the fire scene to dampen a towel and then cover it over his mouth and nose. However, the path to the water source may be blocked by fire at this time. Even water can be got successfully, some precious time has been wasted to lower the possibility of escape from death, to say nothing of finding a towel and then searching for a water source to dampen it. Meanwhile, the fire may have spread to block all escape paths. Moreover, dense smoke may easily let him be not able to effectively use his visual function of eyes, hence losing the possibility of quick escape from death.

### SUMMARY AND OBJECTS OF THE PRESENT INVENTION

Accordingly, the primary object of the present invention is to provide a modified eye and mouth mask structure for escape from dense smoke of fire accident, which can effectively prevent dense smoke from invading the eyes, nose and mouth of a user during the initial stage of a fire accident to increase the possibility of escape from death.

To achieve the above object, the present invention provides a modified eye and mouth mask structure for escape from dense smoke of fire accident, wherein an eye and mouth mask and a liquid bag are together sealed in a package bag when not in use. The eye and mouth mask comprises a mouth mask body, an eye mask body and two constriction bands. The eye mask body is connected at the upper side of the mouth mask body. The eye mask body is made of transparent plastic film. The two constriction bands are sewed at end corners of two side peripheries of the mouth mask body. Once a fire accident occurs, the user can break the liquid bag body to let liquid therein flow out so that a damp eye and mouth mask can be got after the package bag is opened. He can then cover the eye and mouth mask over his eyes, nose and mouth to reduce invasion of dense smoke, hence avoiding faint due to smoke choking. He can thus effectively make use of his visual function of eyes to quickly escape from the fire scene.

The various objects and advantages of the present invention will be more readily understood from the following comprehensive description when read in conjunction with the appended drawings, in which:

### BRIEF DESCRIPTION OF THE DRAWINGS

FIG. 1 is a diagram of an eye and mouth mask unit of the present invention;

FIG. 2 is a diagram showing that a user hits the eye and mouth mask unit to break the liquid bag thereinside;

FIG. 3 is a diagram showing that package bag contains water when the liquid bag is broken;

FIG. 4 is a diagram showing that the eye and mouth mask is unfolded; and

FIG. 5 is a diagram showing the broken liquid bag is taken away from the eye and mouth mask; and

FIG. 6 is a diagram showing that a user wears on the dampened eye and mouth mask in order to cover his eyes, nose and mouth.

### DETAILED DESCRIPTION OF PREFERRED EMBODIMENT

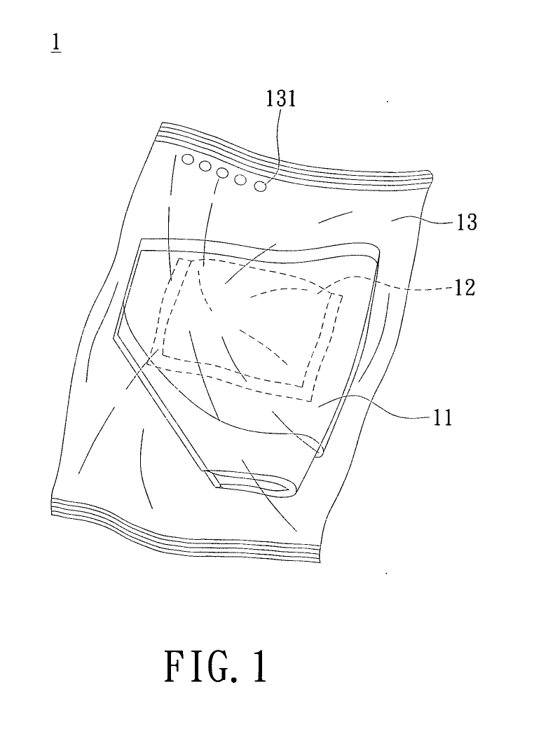

As shown in FIG. 1, the present invention provides a modified eye and mouth mask unit 1 for escape from dense smoke of fire accident, which comprises an eye and mouth mask 11, a liquid bag 12 and a package bag 13. The eye and mouth mask 11 and the liquid bag 12 are contained in the package bag 13 when not in use. The liquid bag 12 contains liquid (e.g., pure water) loaded therein.

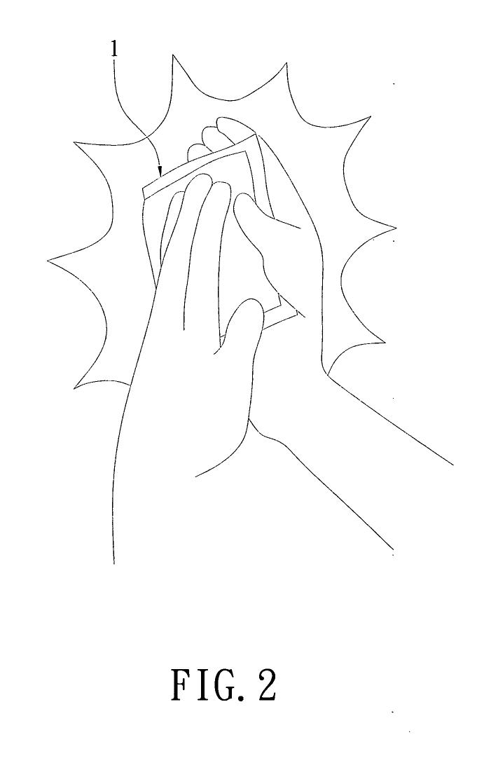

As shown in FIGS. 2 to 6, the eye and mouth mask 11 comprises a mouth mask body 111, an eye mask body 112 and a constriction band 113. The mouth mask body 111 is preferably a multi-layer body. The inner layer of the mouth mask body 111 made of a foam sponge having a high absorbing and air permeating capabilities. A textile layer then sheathes the foam sponge as the outer layer so that the mouth mask body 111 is able to absorb a large quantity of liquid and have a better air permeating capability. A stop edge 115 is formed at the periphery of the mouth mask body 111 to keep liquid inside the mouth mask body 111.

The lower side periphery of the eye mask body 112 is connected to the upper side periphery of the mouth mask body 111 so that the eye mask body 112 is folded downwardly with the mouth mask body 111 when the eye and mouth mask 11 is preserved inside the package bag 13. The eye mask body 112 is made of transparent plastic film so that the user can easily see through the eye mask body 112.

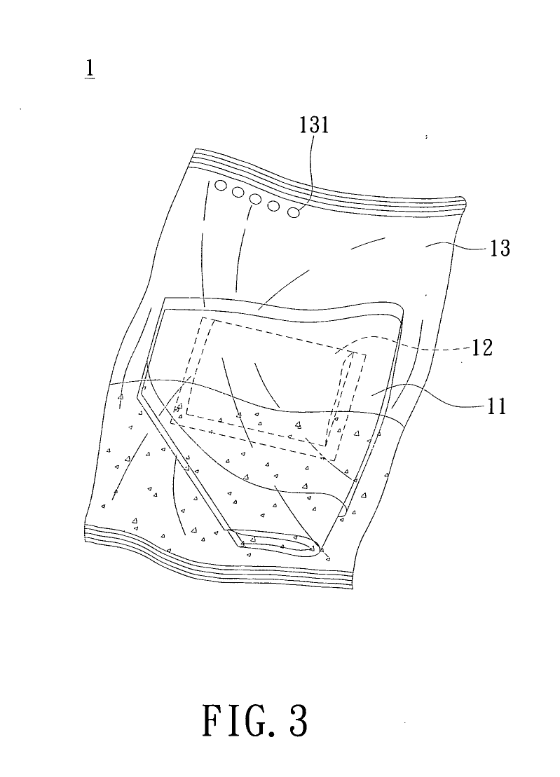

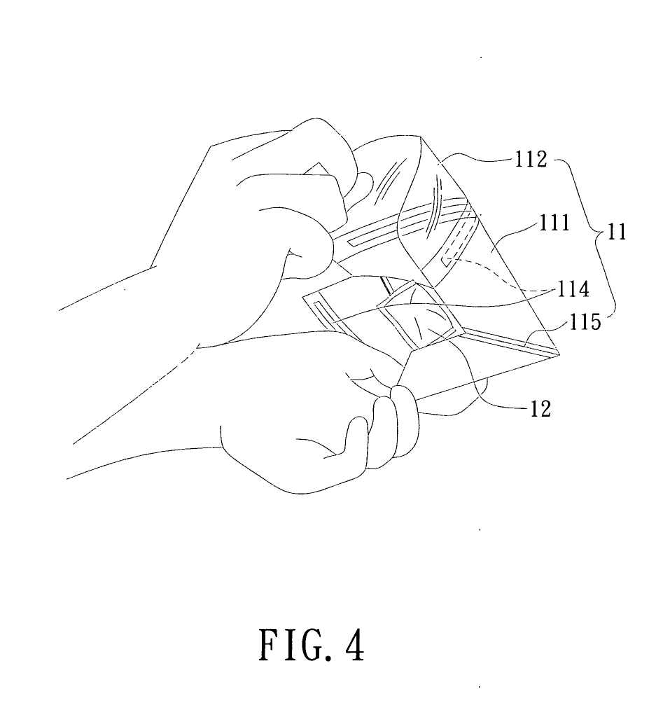

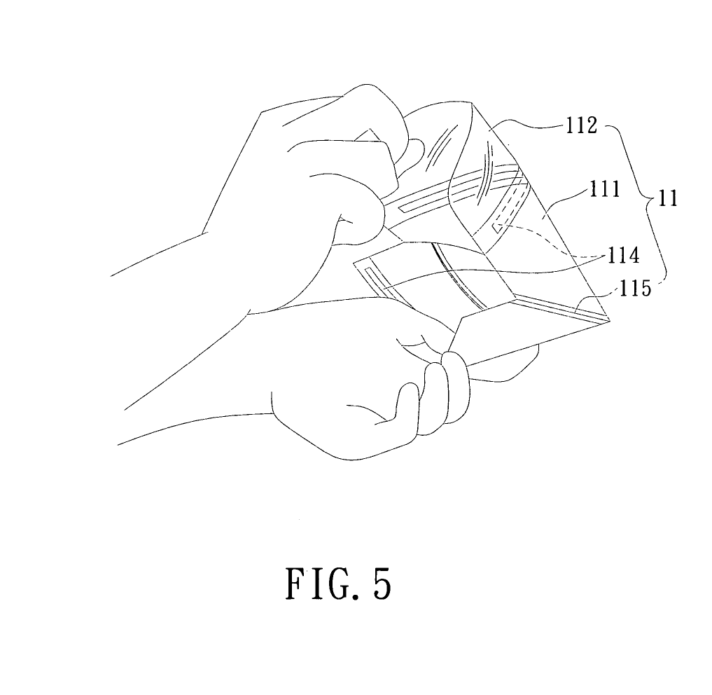

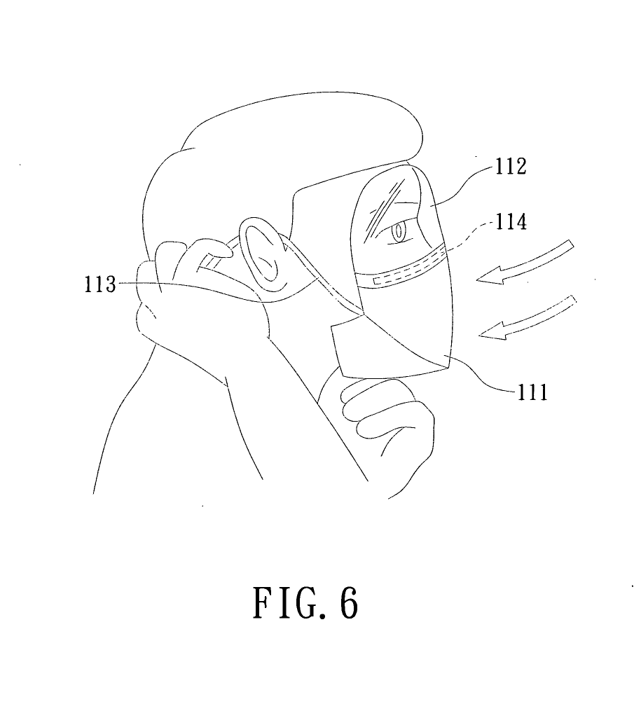

When a first accident occurs, a person can use the eye and mouth mask unit 1 to protect himself from the fire and smoke. First, the person can hit or pinch the package bag 13 until the liquid bag 12 is broken. The upper side of the package bag 13 preferably has a least one vent hole 131 so that air inside the package bag 13 can fast drawn out in order to prevent the package bag 13 from being broken when the person hits the eye and mouth mask unit 1. Therefore, the liquid bag 12 can be broken by human's hands and simultaneously maintain the carrying capacity of the package bag 13 (please refer to FIG. 3). In other words, when the liquid bag 12 is broken, the liquid contained in the liquid bag 12 flows into the package bag 13 in order to dampen the mouth mask body 111 and the eye mask body 112. Because the mouth mask body 111 is made of texture, the mouth mask body 111 can soak and absorb water thereinside. On the other hand, the eye mask body 112 is made of transparent polymer, and the surfaces of the eye mask body 112 are moist because of the water contained in the package bag 13. When the mouth mask body 111 and the eye mask body 112 is very wet after they are dipped in water inside the package bag 13 for a moment, a user can tear open the package bag 13 in order to take out the eye and mouth mask 11 and the liquid bag 12 from the package bag 13. Then, the user can separate the liquid bag 12 from the eye and mouth mask 11 in order to breathe smoothly when he wears on the eye and mouth mask 11. The user first bends the lower periphery of the damp eye mask body 112 to be above the upper side of the mouth mask body 111 (as shown in FIGS. 4 and 5) and remove the liquid bag 12 from the eye and mouth mask 11. Then the user only covers the mouth mask body 111 over his mouth and nose, hangs the constriction band 113 on his head (please refer to FIG. 6), and attaches the flexible and transparent eye mask body 112 with the skin around his eyes using the water on the dampened surface of the eye mask body 112, i.e., the capillarity effect, hence letting the region between his eyes and the eye mask body 12 form a closed region not invaded by dense smoke and thus contributing to quick escape from the fire scene.

The constriction band 13 is sewed at end corners of two side peripheries of the mouth mask body 111 (as shown in FIG. 6) for hanging on the user's ears. However, the eye and mouth mask 11 can comprise more than one constriction band 13 and the constriction band 13 is not illustrated in FIGS. 4-5 for the reason of simplicity. The mouth mask body 111 and the eye mask body 112 of the eye and mouth mask 11 can thus cover over user's eyes, nose and mouth. The mouth mask body 111 and the eye mask body 112 of the eye and mouth mask 11 can also cover over his eyes, nose and mouth. Flexible bars 114 capable of bending and positioning are disposed at upper and lower peripheries of the mouth mask body 111. The flexible bars 114 are plastic bars or soft metallic bars. After the user wears the eye and mouth mask 11, he then presses the upper and lower peripheries of the mouth mask body 111 to adhere the upper and lower peripheries of the mouth mask body 111 to the upper and lower profiles of his face. Therefore, a gap will not form at the periphery of the mouth mask body 11 due to the uneven profile of the user's face to cause dense smoke to invade his eyes, nose and mouth.

To sum up, the eye and mouth mask 11 and the liquid bag 12 are preserved in the package bag 13 when not in use. When a fire accident occurs, the user breaks the liquid bag 12 to let liquid therein flow out from the liquid bag 12 to the package bag 13 so that a dampened eye and mouth mask 11 can be got after the package bag 13 is opened. Furthermore, the liquid bag 12 can be removed from the eye and mouth mask 11 so that user can smoothly breathe without the non-ventilation liquid bag 12 when user wears the dampened eye and mouth mask 11. He can then cover the eye mask body 112 and the mouth mask body 111 individually over his eyes, nose and mouth to reduce invasion of dense smoke, hence avoiding faint due to smoke choking. He can thus effectively make use of his visual function to quickly escape from the fire scene.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A modified eye and mouth mask unit for escape from dense smoke of fire accident, comprising:
an eye and mouth mask for protection against smoke inhalation and eye irritation includes a mouth mask body, an eye mask body and at least one constriction band, said eye mask body being connected at an upper side of said mouth mask body, said eye mask body being made of a flexible transparent plastic film, said constriction band being connected at two side peripheries of said mouth mask body, said mouth mask body including a pair of fixable flexible bar members located at an upper and lower periphery of said mask body; and
a liquid bag, containing water,
a package bag with said eye and mouth mask and said liquid bag unit preserved therein, said package bag containing water when the liquid bag unit is broken so that both the mouth mask body and surfaces of eye mask body are dampened with water in the package bag unit,
wherein said eye and mouth mask is able to unfold to be used when opening said package bag, the broken liquid bag is taken away from the eye and mouth mask and the wet eye and mouth mask is used to protect the user from being harmed in case of a fire so the user cannot inhale the smoke and prevent the smoke from irritating the user's eyes.

2. The modified eye and mouth mask unit for escape from dense smoke of fire accident as claimed in claim 1, wherein the package bag further has at least one vent hole thereon.

3. The modified eye and mouth mask unit for escape from dense smoke of fire accident as claimed in claim 1, wherein said mouth mask body is made of a foam sponge.

4. The modified eye and mouth mask unit for escape from dense smoke of fire accident as claimed in claim 1, wherein said mouth mask body is made of a textile material.

5. The modified eye and mouth mask unit for escape from dense smoke of fire accident as claimed in claim 1, wherein a stop edge is sealed at a periphery of said mouth mask body to avoid washout of water from the periphery of said mouth mask body.

6. The modified eye and mouth mask unit for escape from dense smoke of fire accident as claimed in claim 1, wherein an upper side periphery of said mouth mask body seals a lower side periphery of said eye mask body.

7. The modified eye and mouth mask unit for escape from dense smoke of fire accident as claimed in claim 1, wherein two ends of said constriction band are sewed at end corners of two side peripheries of said mouth mask body.

8. The modified eye and mouth mask unit for escape from dense smoke of fire accident as claimed in claim 1, wherein said dampened surfaces of eye mask body is attached on face skin of the user for preventing the smoke from irritating the user's eyes.
